(19) United States
(12) Patent Application Publication
(10) Pub. No.: US 2004/0111728 A1
(43) Pub. Date: Jun. 10, 2004

(54) Method and system for managing metadata

(76) Inventor: Brian E. Schwalm, Superior, CO (US)

Correspondence Address: MERCHANT & GOULD PC, P.O. BOX 2903, MINNEAPOLIS, MN, 55402-0903, US

(21) Appl. No.: 10/313,655

(22) Filed: Dec. 5, 2002

(51) Int. Cl. G06F 15/16; G06F 15/167; G06F 17/30; G06F 7/00

(52) U.S. Cl. 719/316; 709/203; 707/3

(57) ABSTRACT

A method and system for managing metadata for use by client application programs is disclosed. The client application programs are constructed with various software modules responsible for displaying graphical user interface components to users through a display module, e.g., computer monitor. The graphical user interface components are built using program data and metadata. Program data is data that is entered by a user or generated by a client application program. Metadata is data that describes the program data. The present invention manages metadata using a tri-layer system, which includes a presentation layer, a middle-tier layer and a data layer. The presentation layer includes the client application program, and therefore various software modules used to execute the client application program. The presentation layer also includes an ObjectStore component for managing retrieval and manipulation of metadata for the software modules. Software modules send requests for a metadata object to the ObjectStore component. The ObjectStore component works with the middle-tier layer to extract the requested metadata object from the data layer. The presentation layer, the middle-tier layer and the data layer may reside on a single computer or on multiple computers, such as the case in a client-server environment.

### TECHNICAL FIELD

The invention relates generally to graphical user interfaces for use by an application program, and more particularly, to managing metadata used to create displayed content on graphical user interfaces.

### BACKGROUND OF THE INVENTION

Computer users interact with application programs operating on a computer by way of graphical user interfaces (GUI's) created and displayed by the application programs. An application program may use program data and/or metadata to create and display a GUI. Program data is generally defined as data either received or generated by the application program while the application program is being executed or compiled. Program data may include data entered by a user. Typically, program data is data stored by the application program. The content of program data is independent of the software code executed by the application program. Metadata is generally defined as data that describes or defines other data, which may be program data or other metadata.

In many business-related computer applications, a significant amount of program data is stored in a database for future use. The program data is often user-entered information including, for example, a users' personal information, such as name, address, and telephone information, and complex business information, such as sales figures, inventory information, etc. These business-related computer applications must not only store program data, but also be able to manage, e.g., recall, process and display, the program data in a logical manner.

In order to manage such vast amounts of program data stored in a database, the concept of metadata has evolved. Metadata tags, or entries, distinguish between the different types of program data stored in the database. As an example, metadata may be used to organize program data related to a particular set of employee information for an employee contact, e.g., John Doe, living at 123 Elm Street. Whereas the metadata tag “name” may be associated with “John Doe,” the metadata tag “address” may be associated with “123 Elm Street.” Metadata tags allow computer applications to manage information stored in a database in a quick and efficient manner by providing a means for associating program data with a description.

Often, different types of metadata are actually related to other types of metadata. For example, “business address” metadata may be related to “home address” metadata in that both types of metadata are associated with an address for a contact. Related types of metadata are typically grouped together in tabular form while being stored in a database. These tables may be referred to as definition tables or look-up tables. Definition tables usually have at least two columns and various numbers of rows. Metadata tags are stored in one column of each row of the definition tables. The other column(s) of each row may be used to store a “type code” linking each metadata tag to the program data that the metadata tag describes. These “type codes” are also considered a type of metadata.

Definition tables are used by the various software modules forming an application program to complete GUI components for the GUI of the application program. These definition tables are typically stored in an external database accessible to the software modules for several reasons. First, a definition table may be used by multiple software modules of the application program. It would be vastly inefficient and duplicative for each of these software modules to include the definition table embedded within the programming code of the modules. Second, the actual description contained in each metadata tag of a definition table may vary over the course of development of an application program. If the definition table is embedded within the programming code of multiple software modules, the descriptions contained in the affected metadata tags would have to be amended in the programming code of each of the modules. Storing definition tables in a database accessible to these software modules alleviates the duplication of effort otherwise required while enabling a more efficient way to amend the description of a metadata tag during development.

Calls are typically included within the lines of programming code of a software module that specify the definition tables needed by the software module to complete GUI components for the application program. These calls are performed during execution of an application program to request retrieval of definition tables specified in the calls. As such, each software module of the application program must separately access the database during program execution, regardless of whether one or more software modules are requesting the same or different definition tables. This repetitive process of calling the database not only hinders performance of the application program, but also ties up computer resources most likely needed by other application programs.

One alternative to software modules repetitively and separately extracting definition tables from an external database is for each software module to extract all definition tables at the initialization of the application program. The definition tables are cached locally by each module and retrieved by the software modules when needed for use in populating a GUI component with metadata contained in the tables. However, this approach is problematic in that each software module must include and execute a query for matching program data to a corresponding metadata tag of a cached definition table. The processing overhead associated with this approach is equally as much of a waste of computer resources as the approach noted in the preceding paragraph. Furthermore, if the same definition table is needed by separate software modules of an application program, each software module must retrieve and locally store that definition table. As such, the application program may have multiple instances of a single definition table locally stored on the application program.

### SUMMARY OF THE INVENTION

In accordance with the present invention, the above and other problems are solved by a method and system for managing metadata for use by one or more application programs. The one or more application programs are executed by various software modules performing processes in a programmed sequence. During execution of an application program, the various software modules forming the application program display graphical user interface (GUI) components constructed using both program data and metadata. The metadata used to complete these GUI components is stored in a database in the form of definition tables. Each definition table, as well as each row of a definition table, is a metadata object in an object-oriented computing environment. In an embodiment, the invention uses an ObjectStore component to manage retrieval of metadata objects for the various software modules of an application program. In another embodiment, the ObjectStore component also manipulates the metadata contained within the metadata objects to complete GUI components for the software modules by populating the GUI components with the metadata.

Metadata is managed using a three-layer system having a presentation layer, a middle-tier layer and a data layer in accordance with an embodiment of the present invention. The presentation layer is the “front-end” layer that displays GUI components to users over a display module. The presentation layer includes at least one application program, and therefore software modules that are responsible for executing the application program. In an embodiment, the ObjectStore component is part of the presentation layer, and therefore, the presentation layer manages retrieval and manipulation of metadata for these software modules. The middle-tier layer accesses the data layer to extract metadata therefrom in response to requests by the presentation layer. These layers are not divided by physical boundaries, but rather logical boundaries. As such, the presentation layer, the middle-tier layer and the data layer may all reside on the same computing system, or alternatively, separate computing systems.

In an embodiment, the present invention may be implemented in a client-server environment. In this embodiment, the middle-tier layer includes a server computer that the ObjectStore component accesses over a network connection. The middle-tier layer is connected by communication link to a relational database of the data layer, where metadata is stored in standard and non-standard definition tables. The standard definition tables, which are entered into the database by one or more developers of a client application program, are definition tables pre-formatted for use by the software modules in creating components of a GUI. Each standard definition table includes at least a predetermined set of column fields and at least one row. The column fields include at least a type code field and a metadata description field each being identified by a column name recognizable by the software modules and the ObjectStore component. Like the standard tables, the non-standard tables include, without limitation, a column of type code entries and a column of metadata description entries. However, the names of these columns are not recognizable by the software modules and the ObjectStore component. As such, non-standard definition tables are not pre-formatted for use by either the software modules or the ObjectStore component, and therefore additional manipulation is performed by the middle-tier layer to match the type code entries and metadata description entries to names, or identifiers, recognizable by the software modules and the ObjectStore component.

In order to request metadata to be used to complete a GUI component that is to be displayed by a software module of the client application program, the software module creates an instance of the ObjectStore component. Once created, the software module sends a request to the ObjectStore component for the needed metadata. In an embodiment, the request may specify a definition table identifier corresponding to the standard definition table requested by the software module. The requested definition table contains the metadata required for creation of the GUI component. The request is received by the ObjectStore and forwarded to the server computer. The server computer accesses the database, retrieves the requested standard definition table and provides the table to the ObjectStore component. The ObjectStore component is then responsible for managing the standard definition table. Such management may include, without limitation, caching the table to local memory, populating the GUI component with metadata stored in the table, providing the GUI component to the software module, and providing the table to the software module such that the software module may populate the GUI component with metadata stored in the table.

In another embodiment, the request by the software module may specify a custom query identifier rather than a definition table identifier. A custom query identifier specifies a custom query defining metadata that is to be pulled from one or more non-standard definition tables and used in constructing a custom definition table. Upon receiving such a request, the ObjectStore component forwards the custom query identifier to the server computer. The server computer first extracts the custom query from the relational database. Once extracted, the server computer executes the custom query to retrieve metadata from one or more non-standard definition tables as well as one or more corresponding type code and metadata description entry identifiers. Once retrieved, the identifiers and metadata are provided to the ObjectStore component, which thereafter creates the custom definition table using only the predetermined set of column fields associated with the retrieved metadata. In this embodiment, the type code and metadata description columns of the custom definition tables provided to the software modules of the client application program are identified by substantially the same column names as standard definition tables. Once created, custom definition tables are managed by the ObjectStore component as described in the preceding paragraph.

The invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 illustrates a system for managing metadata for use by application programs in accordance with an embodiment of the present invention.

FIG. 2 illustrates an embodiment of the system of FIG. 1 in more detail in accordance with a particular embodiment of the present invention, including a component for managing retrieval and manipulation of metadata for use by software modules of a client application, a server computer and a database for storing the metadata.

FIG. 3 illustrates an exemplary communications environment for use by the system shown in FIG. 2 in accordance with an embodiment of the present invention.

FIG. 4 depicts a block diagram of a suitable computing environment in which an embodiment of the present invention may be implemented.

FIG. 5 is a flow diagram that illustrates operational characteristics for managing retrieval of metadata for use by a software module of the client application program shown in FIG. 2 in accordance with an embodiment of the present invention.

FIG. 6 is a flow diagram that illustrates operational characteristics shown in FIG. 5 in more detail in accordance with an embodiment of the present invention.

FIG. 7 is a flow diagram that illustrates operational characteristics for managing manipulation of metadata for use by a software module of the client application program shown in FIG. 2 in accordance with an embodiment of the present invention.

FIG. 8 is a flow diagram that illustrates operational characteristics for managing creation and retrieval of definition tables stored in the database shown in FIG. 2 in accordance with an embodiment of the present invention.

### DETAILED DESCRIPTION

The present invention and its various embodiments are described in detail below with reference to the figures. When referring to the figures, like structures and elements shown throughout are indicated with like reference numerals.

The present invention provides a method and system for managing metadata for use by application programs operating on one or more computer systems. As described in more detail in the Background section (above), metadata is data that describes program data. Program data is data generated or received by an application program. In an embodiment, program data refers to data input by users entering information to the computer system by way of a keyboard or mouse. For example, one form of program data would be a user's address entered into an address book application program. Corresponding metadata would be a description that the user's address is a home address.

Program data may be linked to corresponding metadata using a type code. The type code is not displayed to the user, but rather only used internal to the application program. Tables 1 and 2, below, illustrate the difference in program data and metadata and illustrate how type codes are used to link metadata to program data. For example, the type code “hme” links the program data “123 South Avenue” to corresponding metadata “home address.” Table 1 represents an object that stores program data in tabular form using at least two columns and one or more rows. Table 2 represents an object that stores metadata in tabular form using at least two columns and one or more rows. Objects that store metadata are herein referred to as “definition tables.” In an embodiment, each row of a definition table is an object referred to as a row object. A row object includes fields, or entries, defined by the columns of the definition table. In an embodiment, a first field of a row object contains a type code and second field contains description metadata corresponding to program data associated with the same type code.

Each definition table is associated with an identifier that distinguishes that definition table from other definition tables. In an embodiment, each identifier is contained in a single column of the definition table, as shown below in Table 2. Although shown in Table 2 as having only two row objects, definition tables may include any number of row objects.

TABLE 1

| Type Code | Program Data |
|---|---|
| off | 170 Business Street |
| hme | 123 South Avenue |

TABLE 2
Identifier: 000

| Type Code | MetaData |
|---|---|
| off | Business Address |
| hme | Home Address |

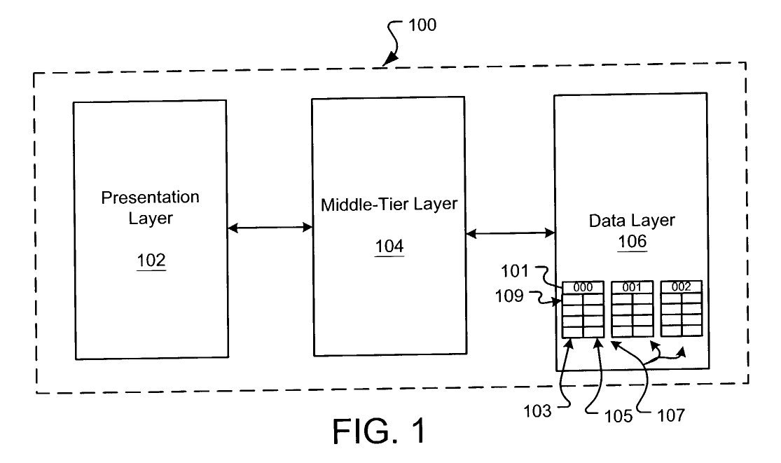

Referring to FIG. 1, a conceptual illustration of a metadata management system 100 is shown in accordance with an embodiment of the present invention. The metadata management system 100 is generally shown and described as a three-layer system having a presentation layer 102, a middle-tier layer 104 and data layer 106. The presentation layer 102, the middle-tier layer 104 and the data layer 106 operate together to manage metadata that is presented on graphical user interfaces or other screens displayed to users of computers systems.

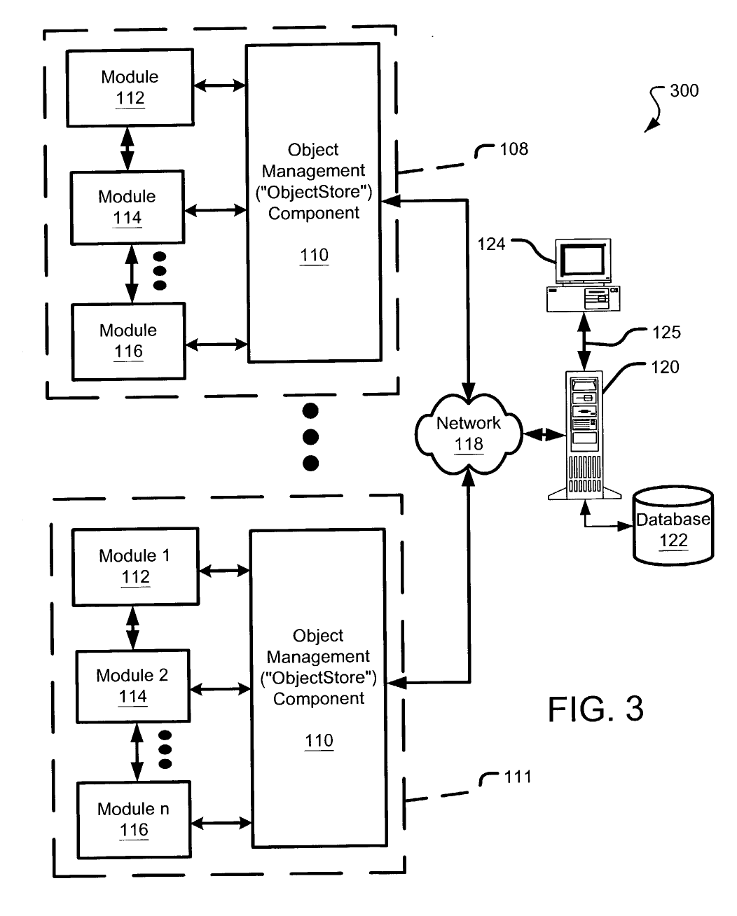

In an embodiment, each of these layers (102, 104 and 106) resides on a single computing system. In another embodiment, at least one of these layers (102, 104 and 106) resides on a computing system separate from the other two layers (102, 104 and 106). For example, the presentation layer 102 may reside on a client computer system and the middle-tier layer 104 and the data layer 106 may both reside on a server computer system. Even further, each layer (102, 104 and 106) may reside on a separate computing system from the other. In either of these latter embodiments, a communications network is employed for communications between the layers (102, 104 and 106) residing on separate computer systems, as shown and described in more detail in FIG. 3. It should be appreciated that each of the layers (102, 104 and 106) operate as described below in FIGS. 1-8 regardless of whether the layers (102, 104 and 106) reside on a single computing system or multiple computing systems.

The presentation layer 102 includes components, modules and processes of application programs that use program data and metadata to create and present graphical user interface (GUI) components to users of computer systems. The GUI components create a GUI, through which users interact with the application program associated with the GUI. Because users interact with application programs through these GUI's, the presentation layer 102 may be referred to as a “front end” layer. The data layer 106 includes processes, components and modules used to store metadata that is used by the presentation layer 102 to fill the GUI components and other screens presented through display modules. In an embodiment, the data layer 106 may also store program data received and/or generated by the application programs residing on the presentation layer 102.

The presentation layer 102 sends requests to retrieve metadata stored within the data layer 106 to the middle-tier layer 104. The middle-tier layer 104 thus serves as a communication liaison between the presentation layer 102 and the data layer 106. The middle-tier layer 104 is responsible for retrieving the requested metadata. After receiving the requested metadata from the middle-tier layer 104, the presentation layer 102 presents the metadata to users of the application program through a GUI presented on a display module. The formatting of the metadata on the GUI, as well as using the metadata to fill one or more GUI components, is discussed in greater detail below and therefore not duplicated in describing FIG. 1.

In accordance with an embodiment, metadata is stored in the data layer 106 in one or more standard definition tables 107. Definition tables 107 are objects in tabular form that contain at least two columns, e.g., 103 and 105, of information and one or more rows, e.g., 109. The rows 109 are objects, i.e., “row objects,” divided into one or more fields by one or more columns, e.g., 103 and 105. For example, without limitation, the rows 109 may be divided into a first field and a second field by a first column 103 and a second column 105, respectively, as shown in FIG. 1.

The definition tables 107 may be of a standard or non-standard format. Standard definition tables, which are entered into the database by one or more developers of a client application program, are definition tables 107 pre-formatted for use by the presentation layer 102 in creating components of a GUI. Each standard definition table includes at least a predetermined set of column fields, e.g., 103 and 105, and at least one row 109. The column fields, e.g., 103 and 105, include at least a type code field and a metadata description field. The column fields, e.g., 103 and 105 include at least a type code field and a metadata description field each being identified by a column name recognizable by the presentation layer 102. Like the standard tables, the non-standard tables include, without limitation, a column of type code entries and a column of metadata description entries. However, the names of these columns are not recognizable by the presentation layer 102. The first field of each row object 109 of a standard definition table stores a type code that links metadata contained in the second field to program data. The program data (not shown) is contained in a data structure and associated with a particular type code included within the first field of an entry, i.e., row, of a standard definition table 107. In an embodiment, this data structure is stored within the data layer 106. In an embodiment wherein the data layer 106 and the presentation layer 102 reside on separate computers, this data structure may be stored or cached in a storage module local to the presentation layer 102.

In an embodiment, standard definition tables 107 also include an identifier 101 that distinguishes each standard definition table 107 from other standard definition tables 107 stored in the data layer 106. The identifier 101 is used by the presentation layer 102 to specify a particular standard definition table 107 needed to for a GUI component. The requests by the presentation layer 102 therefore specify the desired metadata based on the standard definition table identifier 101 included in the requests. The middle-tier layer 104 uses the standard definition table identifier 101 while accessing the data layer 106 to retrieve the requested standard definition table 107. Once retrieved, the standard definition table 107 is provided to the presentation layer 102 by the middle-tier layer 104.

In accordance with another embodiment, the data layer 106 stores custom queries used for transforming metadata contained within non-standard tables into a format which may be used by the presentation layer 102. Each custom query, which is entered into the database by one or more developers of a client application program, is associated with a unique custom query identifier. The data layer 106 also stores identifiers for type codes and metadata entries contained within the non-standard definition tables 107. The identifiers, which are a form of metadata, are names for type code and metadata description columns that are recognizable by the presentation layer 102. When executed, the custom query extracts row objects of non-standard definition tables 107 specified in the query and links type code and metadata description entries within these row objects to corresponding identifiers for the entries.

To request creation of a custom definition table, the request by the presentation layer 102 includes a custom query identifier rather than a definition table identifier 101. In this embodiment, the presentation layer 102 is requesting metadata from one or more non-standard definition tables 107, rather than retrieval of a standard definition table 107. The middle-tier layer 104 uses the custom query identifier to retrieve a custom query from the data layer 106. Once retrieved, the middle-tier layer 104 executes the custom query to extract row objects from one or more non-standard definition tables and link the type code and metadata entry field columns of these row objects to the appropriate identifiers. In an embodiment, the row objects extracted using the custom query encompasses entire rows of fields in a non-standard definition table. In another embodiment, the row objects extracted using the custom query includes only certain fields of the one or more rows defined by the query. After all metadata specified by the custom query is extracted from the data layer 106, the middle-tier layer 104 provides the metadata as well as type code and metadata entry column identifiers to the presentation layer 102. In accordance with a first embodiment, the extracted metadata and identifiers are provided to the presentation layer 102 in raw form and the presentation layer 102 is responsible for constructing a custom definition table using this metadata. In a second embodiment, the middle-tier layer 104 constructs the custom definition table, and thus, provides the extracted metadata to the presentation layer 102 as a constructed definition table formatted with the type code and metadata entry fields being identified by a column name recognizable to the presentation layer 102.

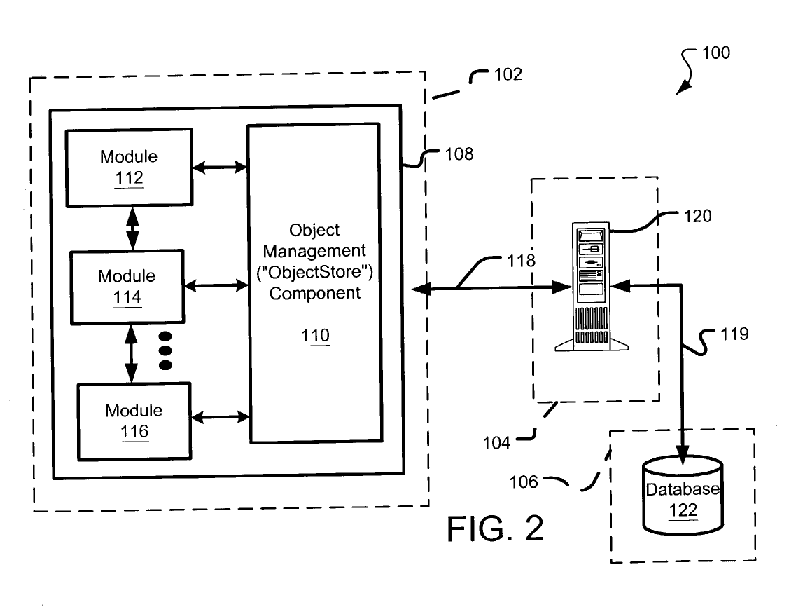

Referring now to FIG. 2, the metadata management system 100 is shown in more detail in accordance with an embodiment of the present invention. The presentation layer 102 is shown having a client application program 108. Although a single client application program 108 is shown, it should be appreciated that the presentation layer 102 may include multiple client application programs. The middle-tier layer 104 is shown having a server computer 120 and the data layer 106 is shown having a database 122. The database 122 is a relational database 122 in that data is stored in tabular form within the database 122. The database 122 stores metadata that is used to populate GUI components requested by the client application program 108. In the embodiment shown in FIG. 2, the client application program 108 resides on a computer system separate from the server computer 120, and therefore, the client application program 108 and the server computer 120 communicate by way of a first communication link 118. The server computer 120 accesses the database 122 over a second communication link 119.

The client application program 108 is constructed using multiple software modules, e.g., module 112, module 114 and module 116. The software modules, e.g., 112, 114 and 116, are the various portions of programming code that form the client application program 108. Hence, the software modules, e.g., 112, 114 and 116, perform processes for executing the program 108. During execution, the client application program 108 presents a GUI (not shown) on a display module. The software modules, e.g., 112, 114 and 116, collectively form the client application program 108 and are responsible for displaying various components that make up the GUI of the client application program 108. Although three software modules are shown, it should be appreciated that the client application program 108 may be constructed using any number of software modules.

The client application program 108 includes an object management (“ObjectStore”) component 110. In an embodiment, the ObjectStore component 110 works with the software modules, e.g., 112, 114 and 116, of the client application program 108 to manage retrieval of metadata for use by the software modules, e.g., 112, 114 and 116, in executing the client application program 108. As a user interacts with the client application program 108, the software modules, e.g., 112, 114 and 116, are executed to generate and present graphical user interface (GUI) components for display on a display module. The GUI components include both program data and metadata.

Each software module, e.g., 112, 114 and 116, utilizes the ObjectStore component 110 to manage retrieval of metadata needed to construct the aforementioned GUI components. The ObjectStore component 110 works with the server computer 120 to effectuate the retrieval of metadata from the database 122. Metadata is stored in the database 122 in tabular form as either a standard or non-standard definition table.

To initiate retrieval of metadata, a software module, for example, the software module 112, creates an instance of the ObjectStore component 110. Once the instance is created, the software module 112 sends a request for specific metadata to the ObjectStore component 110. The request specifies a definition table identifier 101, or alternatively, a custom query identifier, corresponding to the metadata needed by the software module 112. The ObjectStore component 110 receives the request and manages retrieval of the required metadata. The ObjectStore component 110 communicates the definition table identifier 101, or alternatively, the custom query identifier, to the server computer 122. The server computer 122 retrieves the requested standard definition table 107 from the database 122 and provides the metadata to the ObjectStore component 110. If the request specifies a definition table identifier 101, the server computer 122 executes a standard query to retrieve the standard definition table associated with the identifier 101. If the request specifies a custom query identifier, the server computer 122 extracts the custom query from the database 122 and thereafter executes the query to retrieve the appropriate metadata. Once retrieved, the metadata is passed to the ObjectStore component 110. The ObjectStore component 110 provides the requested metadata, which may be contained within a standard or custom definition table, to the software module 112 upon receipt of same.

In an embodiment, the ObjectStore component 110 fills a GUI component with the requested metadata. The GUI component is requested by the software module 112. In this embodiment, the request by the software module 112 includes a blank GUI component that the software module 112 is requesting the ObjectStore component 110 to fill with the requested metadata. The ObjectStore component 110 manipulates the metadata by placing the metadata into a GUI component that is specified in the request by the software component 112. The metadata is therefore provided to the software module 112 in the form of a completed GUI component.

Illustrating this embodiment, the request by the software module 112 may include or specify a drop down list and a definition table identifier 101. The identifier 101 corresponds to a standard definition table 107 having metadata for the drop down list. The ObjectStore component 110 receives this request, and in response, manages retrieval and manipulation of the metadata contained within the specified standard definition table. The ObjectStore component 110 first sends a request for the standard definition table to the server computer 120.

The server computer 120 receives the request from the ObjectStore component 110 and uses the definition table identifier 101 to access and retrieve the appropriate standard definition table. The server computer 120 provides the standard definition table to the ObjectStore component, which then fills the drop down list with metadata contained in the standard definition table to complete the drop down list requested by the software module 112. Once completed, the drop down list is provided to the software module 112. In an alternative embodiment, the ObjectStore component 110 provides the standard definition table to the software module in the form of raw data. In this embodiment, the software module 112 completes the GUI component with metadata contained in the definition table.

Referring now to FIG. 3, an exemplary communications environment 300 for the metadata management system 100 of FIG. 2 is shown in accordance with an embodiment. Multiple client applications, e.g., 108 and 111, communicate with the server computer 120 over a network 118, such as a local area network, a wide area network, the Internet, a virtual private network or Intranet. Each of the client applications, e.g., 108 and 111, are constructed using software modules, e.g., 112, 114 and 116, and include an ObjectStore component 110. The ObjectStore components 110 of each client application, e.g., 108 and 111, manage retrieval, and in accordance with an embodiment, manipulation, of metadata for the client applications, e.g. 108 and 111, as described above with reference to FIG. 2. The client applications, e.g. 108 and 111, may reside on a single computer or separate computers.

In the embodiment shown in FIG. 3, a local workstation 124 is connected to the server computer 120 by a communication link 125. The local workstation 124 is used by software developers to input metadata into the database 122 for storage. The local workstation 124 may serve as a client computer, e.g., a thick or thin client, having one or more client application programs, e.g., 108 and 111. The local workstation 124 also enables software developers to arrange related types of metadata into standard definition tables 110, a form in which the metadata is stored and provided to an ObjectStore component 110 by the server computer 120 in accordance with an embodiment.

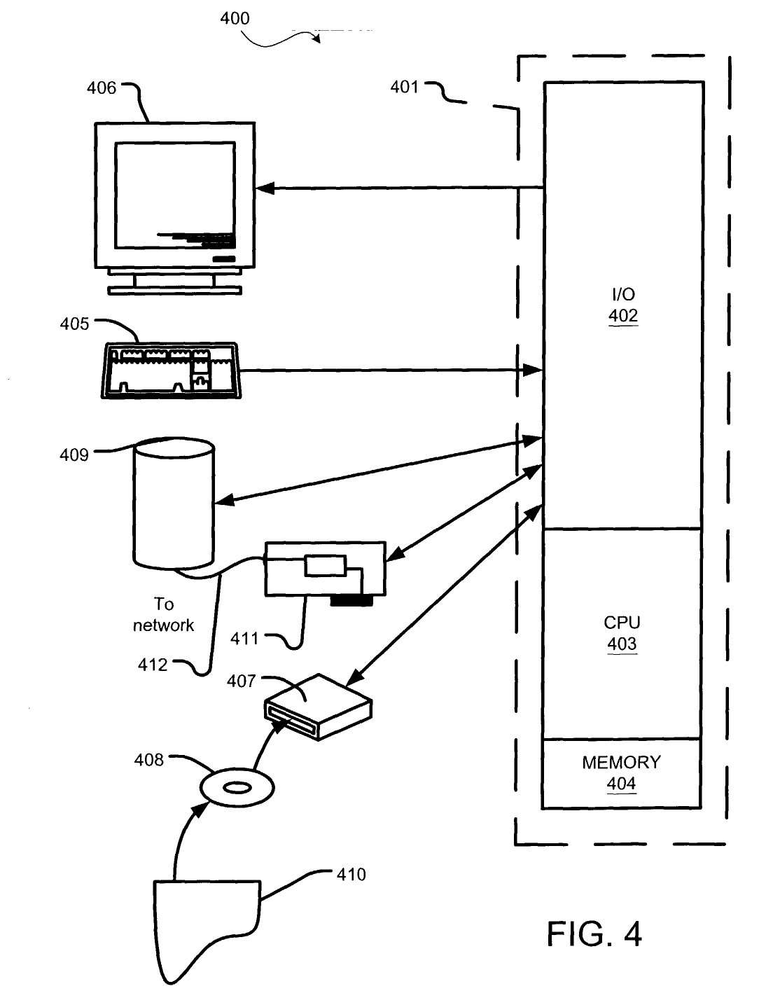

FIG. 4 depicts a general-purpose computing system 400 capable of executing a program product embodiment of the present invention. One operating environment in which the present invention is potentially useful encompasses the general-purpose computing system 400. In such a system, data and program files may be input to the computing system 400, which reads the files and executes the programs therein. Some of the elements of a general-purpose computing system 400 are shown in FIG. 4 wherein a processor 401 is shown having an input/output (I/O) section 402, a Central Processing Unit (CPU) 403, and a memory section 404. The present invention is optionally implemented in software devices loaded in memory 404 and/or stored on a configured CD-ROM 408 or storage unit 409 thereby transforming the computing system 400 to a special purpose machine for implementing the present invention.

The I/O section 402 is connected to a keyboard 405, a display unit 406, a disk storage unit 409, and a disk drive unit 407. In accordance with one embodiment, the disk drive unit 407 is a CD-ROM driver unit capable of reading the CD-ROM medium 408, which typically contains programs 410 and data. Computer program products containing mechanisms to effectuate the systems and methods in accordance with the present invention may reside in the memory section 404, the disk storage unit 409, or the CD-ROM medium 408 of such a system. In accordance with an alternative embodiment, the disk drive unit 407 may be replaced or supplemented by a floppy drive unit, a tape drive unit, or other storage medium drive unit. A network adapter 411 is capable of connecting the computing system 400 to a network of remote computers via a network link 412. Examples of such systems include SPARC systems offered by Sun Microsystems, Inc., personal computers offered by IBM Corporation and by other manufacturers of IBM-compatible personal computers, and other systems running a UNIX-based or other operating system. A remote computer may be a desktop computer, a server, a router, a network PC (personal computer), a peer device or other common network node, and typically includes many or all of the elements described above relative to the computing system 400. Logical connections may include a local area network (LAN) or a wide area network (WAN). Such networking environments are commonplace in offices, enterprise-wide computer networks, intranets, and the Internet.

In accordance with a program product embodiment of the present invention, software instructions, such as instructions directed toward communicating data between a client and a server, detecting product usage data, analyzing data, and generating reports, may be executed by the CPU 403; and data, such as products usage data, corporate data, and supplemental data generated from product usage data or input from other sources, may be stored in memory section 404, or on the disk storage unit 409, the disk drive unit 407 or other storage medium units coupled to the system 400.

As is familiar to those skilled in the art, the computing system 400 further comprises an operating system and usually one or more application programs. The operating system comprises a set of programs that control operations of the computing system 400 and allocation of resources. The set of programs, inclusive of certain utility programs, also provide a graphical user interface to the user. An application program is software that runs on top of the operating system software and uses computer resources made available through the operating system to perform application specific tasks desired by the user. In accordance with an embodiment, the operating system may employ a graphical user interface wherein the display output of an application program is presented in a rectangular area on the screen of the display device 406. The operating system is operable to multitask, i.e., execute computing tasks in multiple threads, and thus may be any of the following: Microsoft Corporation's “WINDOWS 95,” “WINDOWS CE,” “WINDOWS 98,” “WINDOWS 2000,” “WINDOWS NT” or “WINDOWS XP” operating systems, IBM's OS/2 WARP, Apple's MACINTOSH SYSTEM 8 operating system, X-windows, etc.

In accordance with the practices of persons skilled in the art of computer programming, the present invention is described below with reference to acts and symbolic representations of operations that are performed by the computing system 400, a separate storage controller or a separate tape drive (not shown), unless indicated otherwise. Such acts and operations are sometimes referred to as being computer-executed. It will be appreciated that the acts and symbolically represented operations include the manipulations by the CPU 403 of electrical signals representing data bits causing a transformation or reduction of the electrical signal representation, and the maintenance of data bits at memory locations in the memory 404, the configured CD-ROM 408 or the storage unit 409 to thereby reconfigure or otherwise alter the operation of the computing system 400, as well as other processing signals. The memory locations where data bits are maintained are physical locations that have particular electrical, magnetic, or optical properties corresponding to the data bits.

The logical operations of the various embodiments of the present invention are implemented (1) as a sequence of computer-implemented steps running on a computing system 400 and/or (2) as interconnected machine modules within the computing system 400. The implementation is a matter of choice dependent on the performance requirements of the computing system 400 implementing the invention. Accordingly, the logical operations making up the embodiments of the present invention described herein are referred to alternatively as operations, acts, steps or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

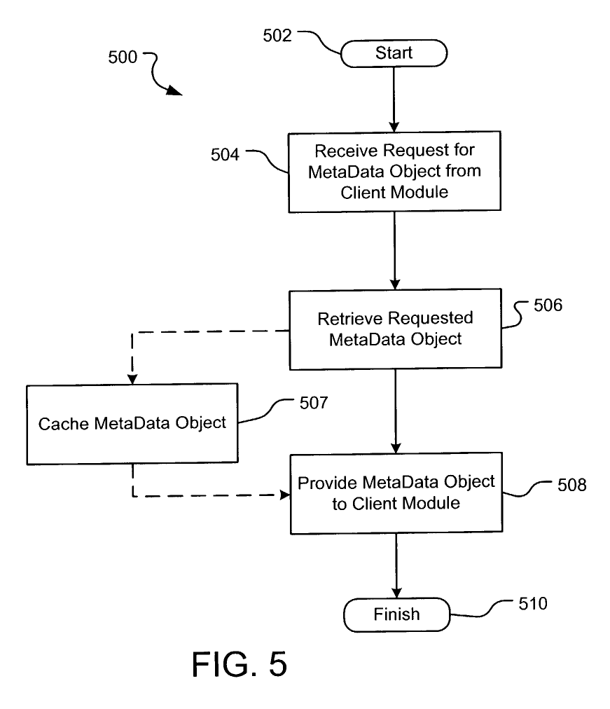

Referring now to FIG. 5, a process 500 generally illustrating operations for managing metadata for use by a client application program is shown in accordance with an embodiment of the present invention. The management process 500 is described below with reference to the metadata management system 100 shown in FIG. 2. However, the management process 500 may be performed with any metadata management system configuration having a presentation layer 102, a middle-tier layer 104 and a data layer 106.

With the embodiment of FIG. 2 in mind, the management process 500 is a flow of operations performed by the ObjectStore component 110 residing on the client application program 108. As noted above with reference to FIG. 2, the ObjectStore component 110 manages retrieval and manipulation of metadata for the client application program 108. Each entry of metadata corresponding to a particular type code is stored in a database 122 as a row object contained in a table object. The table objects may be formatted as either standard or non-standard definition tables. The ObjectStore component 110 manages retrieval of both standard definition table objects and row objects from non-standard definition tables. The management process 500 is therefore described below as software modules, e.g., 112, 114 and 116, request and the ObjectStore manages “metadata objects,” which encompass standard definition tables and row objects from both standard definition tables and non-standard definition tables.

The management process 500 is performed using a flow of operations, i.e., an “operation flow,” beginning with a start operation 502 and concluding with a terminate operation 510. The start operation 502 is initiated by a software module 112 creating an instance of the ObjectStore component 110 for use in retrieving and managing metadata. From the start operation 502, the operation flow passes to a receive operation 504. The receive operation 504 receives a request from a software module, e.g., 112, 114 and 116, of the client application program 108 for one or more metadata objects. Although requests by software modules can, and often are, made for a plurality of metadata objects, for clarity, the management process 500 is hereinafter described as managing a single metadata object in response to a request by a software module, e.g., 112, 114 and 116, for the single metadata object.

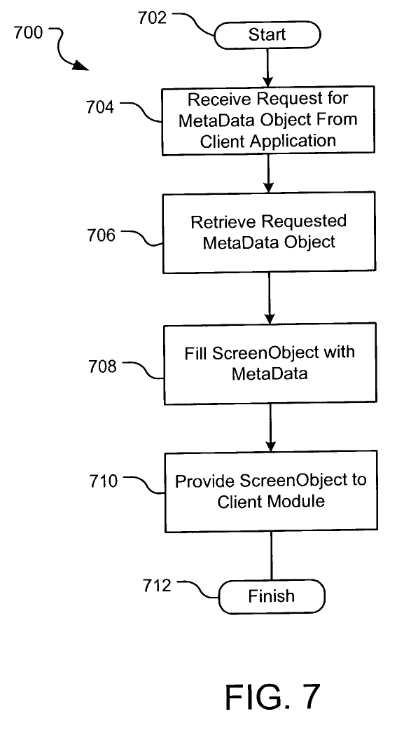

The metadata object will be used to complete a GUI component that will be displayed by the software module, e.g., 112, 114 and 116, to a user of the client application program 108 through a display monitor. In an embodiment, the request by the software module, e.g., 112, 114 and 116, includes this GUI component, thereby implicitly requesting the ObjectStore component 110 to perform the task of filling the GUI component with the metadata contained within the specified metadata object. Such an embodiment is shown and described in more detail in FIG. 7. In an alternative embodiment, the request by the software module, e.g., 112, 114 and 116, does not include the GUI component, and thus, the software module, e.g., 112, 114 and 116, is only requesting that the ObjectStore component 110 provide it with the specified metadata object. After the request by the software module, e.g., 112, 114 and 116, is received, the operation flow passes to a retrieval operation 506.

The retrieval operation 506 retrieves the metadata object specified in the request received by the receive operation 504. The specified metadata object is stored in, and therefore retrieved from, a database 122 of the data layer 106. In accordance with the embodiment shown in FIG. 2, the ObjectStore component 110 works with the server computer 120 to retrieve the specified metadata object. In this embodiment, the server computer 120 accesses the database 122 to retrieve the specified metadata object in response to such a request from the retrieval operation 506. In other embodiments, the ObjectStore component 110 may reside on the middle-tier layer 104, and thus, the retrieve operation 504 includes accessing the data layer 106, and more specifically, the database 122, to retrieve the specified metadata object.

In one embodiment, after the specified metadata object is retrieved, the operation flow passes directly to a provide operation 508. The provide operation 508 provides the retrieved metadata object to the software module, e.g., 112, 114 and 116, that has requested the object. In accordance with another embodiment, the operation flow passes from the retrieval operation 506 to a cache operation 507, and then from the cache operation 507 to the provide operation 508.

The cache operation 507 caches the retrieved metadata object to a “session” cache memory as well as an “instance” cache memory. The session cache memory stores the metadata object so long as the user of the client application program 108 is logged on to a session of the program 108. All instances executing for the ObjectStore component may access the session cache. Instances of the ObjectStore component 110 store metadata objects so long as the instance of the ObjectStore component 110 requesting the metadata is still executing. Thus, the metadata object requested by a software module 112 is only available to the software modules 112 that created the instance. By caching the metadata object, the process of accessing the database 122 to retrieve the metadata object may be by-passed in favor of accessing the local cache memory, thereby improving performance and efficiency. After the retrieved metadata object is cached, the metadata object is provided to the software module, e.g., 112, 114 and 116, by the provide operation 508.

If the request received by the receive operation 504 includes a GUI component, the provide operation 508 provides the metadata object to the software module, e.g., 112, 114 and 116, in the form of a completed GUI component. Otherwise, the metadata object is provided to the software module, e.g., 112, 114 and 116, in the form raw data. From the provide operation 508, the operation flow concludes at the terminate operation 510.

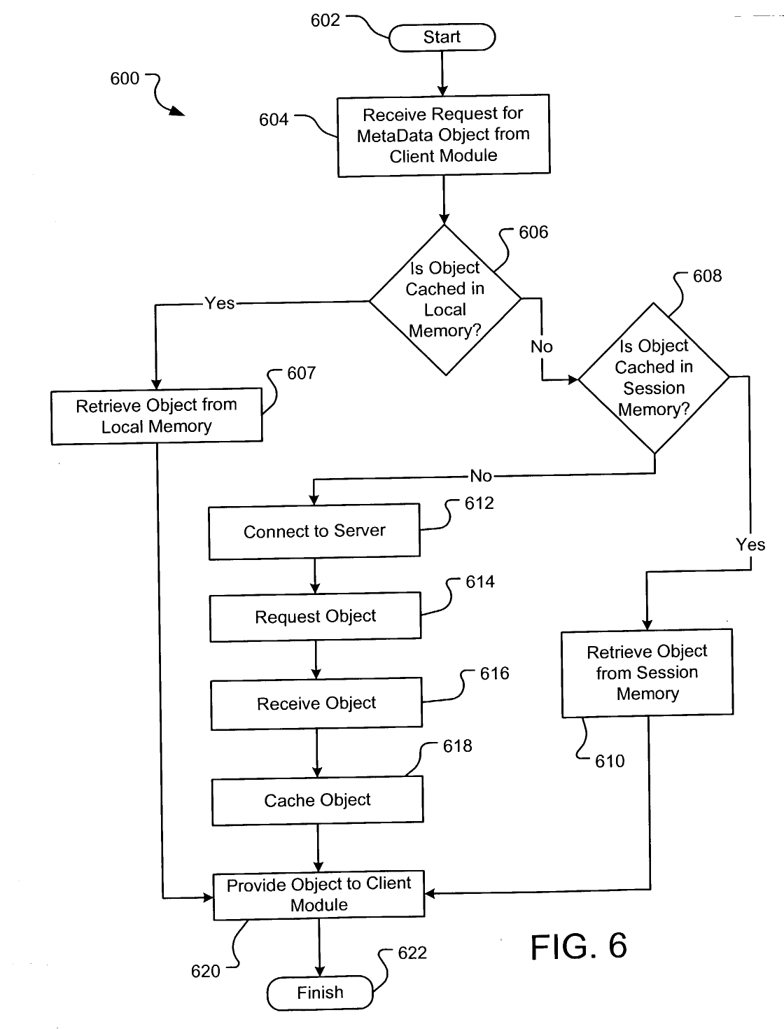

FIG. 6 illustrates operations of the metadata management system 100 as the ObjectStore component 110 manages retrieval of metadata objects for a client application program in accordance with an embodiment of the present invention. FIG. 6 shows a management process 600 illustrating in more detail operations of the management process 500. The management process 600 shown in FIG. 6 is performed by an operation flow that begins with a start operation 602 and concludes with a terminate operation 622. The start operation 602 is initiated by a software module 112 creating an instance of the ObjectStore component 110 for use in retrieving and managing metadata. From the start operation 602, the operation flow passes to a receive operation 604.

The receive operation 604 receives a request from a software module, e.g., 112, 114 and 116, of the client application program 108 for one or more metadata objects. The one or more metadata objects are specified based on an identifier included within the request. As described above, such a request may include a definition table identifier or a custom query identifier. If the request includes a definition table identifier, the metadata object specified in the request is a standard definition table. In contrast, if the request includes a custom query identifier, the metadata object specified in the request is a custom definition table constructed of row objects retrieved from one or more non-standard definition table.

Although requests by software modules, e.g., 112, 114 and 116, may specify a plurality of metadata objects, for clarity, the management process 500 is hereinafter described as managing a single metadata object in response to a request by a software module, e.g., 112, 114 and 116, for the single metadata object. Metadata contained in the metadata object will be used to fill a GUI component that will be displayed by the software module, e.g., 112, 114 and 116, to a user of the client application program 108 through a display monitor. In an embodiment, the request by the software module, e.g., 112, 114 and 116, includes this GUI component, thereby implicitly requesting 110 the ObjectStore component 110 to perform the task of filling the GUI component with the metadata contained within the specified metadata object. Such an embodiment is shown and described in more detail in FIG. 7. In an alternative embodiment, the request by the software module, e.g., 112, 114 and 116, does not include the GUI component, and thus, the software module, e.g., 112, 114 and 116, is only requesting that the ObjectStore component 110 provide it with the specified metadata object. After the request by the software module, e.g., 112, 114 and 116, is received, the operation flow passes to first query operation 606.

In accordance with an embodiment, metadata objects that have been retrieved by an instance of the ObjectStore component 110 from the database 122 over a predetermined period of time are stored in cache memory local to the instance. This memory is referred to herein as “instance cache.” These retrieved metadata objects are stored in the form of definition tables in the instance cache for as long as the instance remains active. During this time, metadata objects stored in the instance cache are available to the software module 112 that created the instance.

The first query operation 606 accesses the instance cache 110 to check whether the metadata object specified in the received request is stored therein. If the specified metadata object is stored in the instance cache when the first query operation 606 accesses the memory, the operation flow passes to a first retrieval operation 607.

The first retrieval operation 607 retrieves the specified metadata object from the instance cache. After the specified metadata object is retrieved by the first retrieval operation 607, the operation flow passes to a provide operation 620. The provide operation 620 provides the retrieved metadata object to the software module, e.g., 112, 114 and 116, that has requested the object. If the request received by the receive operation 604 includes a GUI component, the specified metadata object is provided to the software module, e.g., 112, 114 and 116, in the form of a completed GUI component. Otherwise, the specified metadata object is provided to the software module, e.g., 112, 114 and 116, in the form raw data. From the provide operation 620, the operation flow concludes at the terminate operation 622.

If the first query operation 606 does not find the specified metadata object in the cache memory of the ObjectStore component 110, the operation flow passes from the first query operation 606 to a second query operation 608. In addition to being stored in an instance cache, metadata objects extracted from the database 122 are stored in cache memory local to the client application program 108 in the form of definition tables. In contrast to instance cache, metadata objects located within the session cache are available to all instances of the ObjectStore component 110 currently being executed or later activated by a software module, e.g., 112, 114 and 116, until such time that the user logs off the client application program 108. As such, the session caches is erased after each run-time session for the client application program 108. A run-time session is generally defined as the time during which the client application program 108 is executed for use by a user or computer. The second query operation 608 accesses the session cache to check whether the specified metadata object is stored therein.

If the specified metadata object is stored in the session cache when the second query operation 608 accesses the cache, the operation flow passes to a second retrieval operation 610. Under such circumstances, the specified metadata object has been retrieved for a software module, e.g., 112, 114 and 116, of the client application program 108 during the current run-time session for the client application program 108. The second retrieval operation 610 retrieves the specified metadata object from the session cache. After the specified metadata object is retrieved, the operation flow passes to the provide operation 620 and continues as previously described.

If the specified metadata object is not stored in the session cache when the second query operation 608 accesses the memory, the operation flow passes to a connect operation 612. The connect operation 612 connects the ObjectStore component 110 to the server computer 120. In an embodiment, this connection may be made over a network, such as, without limitation, the Internet, an Intranet, a local area network, a virtual private network or a wide area network. After the ObjectStore component 110 is connected to the server computer 120, the operation flow passes to a request operation 614.

The request operation 614 sends a communication to the server computer 120 requesting the metadata object specified in the request by the software module 112. In response, the server computer 120 accesses the database 122 to retrieve the specified metadata object in response to the request sent by the request operation 614. From the request operation 614, the operation flow passes to a receive operation 616. The receive operation 616 receives the specified metadata object from the server computer 120 over the network connection. If the specified metadata object is a standard definition table, the standard definition table is received by the receive operation 616. In contrast, if the specified metadata object is a custom definition table, one or more type code and metadata entry column identifiers and one or more row objects are received by the receive operation 616 are parsed into a definition table.

From the receive operation 616, the operation flow passes to a cache operation 618. The cache operation 618 caches the received metadata object to the instance cache of the ObjectStore component 110 as well as the session cache of the client application program 108. The object is stored in the instance cache, and thus available to the software module 122 that created the instance, for the duration of time period that the instance is active. The object is stored in the session cache, and thus available to all software modules, e.g., 112, 114 and 116, of the client application program 108 for the duration of the user's session. From the cache operation 618, the operation flow passes to the provide operation 620 and continues as previously described.

Referring now to FIG. 7, a process 700 generally illustrating operations for managing retrieval and manipulation of metadata for use by a client application program is shown in accordance with an embodiment of the present invention. The management process 700 is described below with reference to the metadata management system 100 shown in FIG. 2. However, the management process 700 may be performed with any metadata management system configuration having a presentation layer 102, a middle-tier layer 104 and a data layer 106.

With the embodiment of FIG. 2 in mind, the management process 700 is a flow of operations performed by the ObjectStore component 110 residing on the client application program 108. Although requests by software modules, e.g., 112, 114 and 116, may specify a plurality of metadata objects, for clarity, the management process 700 is hereinafter described as managing a single metadata object in response to a request for the single metadata object. The metadata object is used by the management process 700 to complete a GUI component that will be displayed by the software module, e.g., 112, 114 and 116, to a user of the client application program 108 through a display monitor. The management process 700 is performed using an operation flow beginning with a start operation 702 and concluding with a terminate operation 712. The start operation 702 is initiated by a software module 112 creating an instance of the ObjectStore component 110 for use in retrieving and managing metadata. From the start operation 702, the operation flow passes to a receive operation 704.

The receive operation 704 receives a request from a software module, e.g., 112, 114 and 116, of the client application program 108 for one or more metadata objects. The one or more metadata objects are specified based on an identifier included within the request. As described above, such a request may include a definition table identifier or a custom query identifier. If the request includes a definition table identifier, the metadata object specified in the request is a standard definition table. In contrast, if the request includes a custom query identifier, the metadata object specified in the request is a custom definition table constructed of row objects retrieved from a non-standard definition table. After the request by the software module, e.g., 112, 114 and 116, is received by the receive operation 704, the operation flow passes to a retrieval operation 706.

The retrieval operation 706 retrieves the metadata object specified in the request received by the receive operation 704. Such a retrieval operation 706 is described in detail with reference to the management process 600. In accordance with an embodiment, the request by the software module, e.g., 112, 114 and 116, includes a GUI component, thereby implicitly requesting the ObjectStore component 110 to fill the GUI component with metadata contained in the specified metadata object. In another embodiment, the request by the software module, e.g., 112, 114 and 116, includes an identification of the GUI component, rather than the actual component. In this embodiment, the retrieve operation 706 uses this identification to retrieve the component from the database 112.

From the retrieve operation 706, the operation flow passes to a fill component operation 708. As noted above, blank version of the GUI component may be either included within the request received by the receive operation 704 or, alternatively, retrieved from the database 122. The fill component operation 708 fills the GUI component using metadata contained in the metadata object retrieved from the database 122. After the GUI component is completed, the operation flow passes to a provide operation 710. The provide operation 710 provides the completed GUI component to the software module, e.g., 112, 114 and 116. From the provide operation 710, the operation flow concludes at the terminate operation 612.

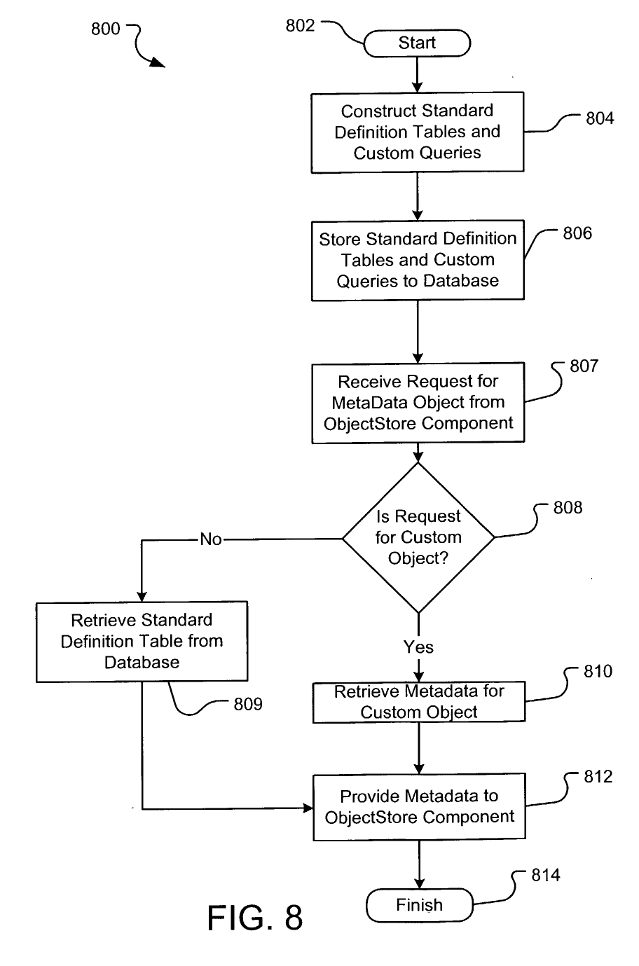

Referring now to FIG. 8, a process 800 generally illustrating operational characteristics for managing creation and retrieval of definition tables by the middle-tier layer 104 is shown in accordance with an embodiment of the present invention. The management process 800 is described below with reference to the metadata management system 100 shown in FIG. 2. The management process 800 of FIG. 8 therefore illustrates operations performed by the server computer 120. The management process 800 is performed by an operation flow beginning with a start operation 802 and ending with a terminate operation 814. From the start operation 802, the operation flow passes to a first build operation 804.

The first build operation 804 constructs standard definition tables having related types of metadata. Each standard definition table contains one or more row objects having a predetermined set of metadata fields. The predetermined set of metadata fields are selected by the developer of the client application program 108. In an embodiment, the predetermined set includes one or more type codes and an equal number of metadata description entries. Each type code and its corresponding metadata description entry are included within a row object in a standard definition table. The type codes are grouped in a first column of each row object and the metadata description entries are grouped in a second column of each row object. Being standard definition tables, these columns are identified by names recognizable to both the ObjectStore component 110 and client application program 108. Although not described, the row object may have additional fields and/or entries as well. As such, the first build operation 804 constructs at least two types of objects, with a first object type being the standard definition table and a second object type being the rows in the standard definition table.

In an embodiment, the metadata description entries used to complete GUI components for client application programs by filling the GUI components with the metadata description entries. For example, a standard definition table may include metadata related to physical addresses of contacts in an address book application program, as shown in Table 2. A metadata description entry associated with a home address and a metadata description entry associated the office address will be used to complete a GUI component for the address book application program.

The determination of which standard definition tables are constructed by the first build operation 804 is based on the metadata needed by various client application programs that will access the database 122 to retrieve metadata description entries for creation of GUI components. One or more software developers input these standard definition tables using a computer system connected to the server computer 120, such as workstation 124 shown in the embodiment of FIG. 3.

In accordance with an embodiment, the database also stores non-standard definition tables. Like the standard tables, non-standard tables include, without limitation, a column of type code entries and a column of metadata description entries. However, the names of these columns are not recognizable by the software modules and the ObjectStore component. As such, non-standard definition tables are not pre-formatted for use by either the client application program 108 or the ObjectStore component 110, and therefore additional manipulation is performed by the middle-tier layer 104 to match the type code entries and metadata description entries to names, or identifiers, recognizable by the software modules and the ObjectStore component. Such additional manipulation is accounted for through the use of custom queries.

To utilize metadata stored in these non-standard tables, a request for the metadata specifies a custom query that is to be executed by the server computer 120. As such, the first build operation 804 constructs one or more custom queries defined by the software developer of the client application program 108 which are to be used to extract metadata from non-standard definition tables for use in constructing custom definition tables. Furthermore, the construct operation 804 associates type code and metadata description columns of each non-standard definition table with an identifier that is recognizable by both the ObjectStore component 110 and the client application program 108.

After the standard definition tables, custom queries and identifiers for type code entries and metadata description entries are constructed by the first build operation 804, the operation flow passes to a storage operation 806. The storage operation 806 saves these definition tables, custom queries and identifiers to the database 122. In accordance with an alternative embodiment, the first build operation 804 is by-passed and the operation flow begins with the storage operation 806 receiving previously constructed standard definition tables and custom queries. This embodiment occurs if a software developer uses a separate computer system to build the standard definition tables, custom queries and identifiers, but uses the server computer 120 to load the standard definition tables 107 into the database 122. As noted above, the software developer may access the server computer 120 through the workstation 124, or some other client computer system connected to the server computer 120 over a connection to the network 118.

Once stored in the database 122, the standard definition tables, custom queries and identifiers may be accessed by the server computer 120 and provided to the ObjectStore component 110 for completion of GUI components. As noted above, the GUI component may be completed, i.e., populated with metadata, by either the ObjectStore component 110 or the software module, e.g., 112, 114 and 116, that has requested the metadata object. From the store operation 806, the operation flow passes to a receive operation 807. The receive operation 807 receives a request from the ObjectStore component 110 for a metadata object. The metadata object may be a standard definition table or a custom definition table. Whereas a standard definition table is requested using a definition table identifier 101, a custom definition table is requested using a custom query identifier. After this request is received, the operation flow passes to a query operation 808.

The query operation 808 determines whether the metadata object specified in the received request is a standard definition table or a custom definition table. This determination is made based on whether the request includes a definition table identifier 101 or a custom query identifier. If the request includes a definition table identifier 101, the ObjectStore component 110 has requested a standard definition table 107. Otherwise, if the request includes a custom query identifier, the ObjectStore component 110 has requested one or more row objects from one or more non-standard definition tables. If the query operation 808 determines that the request specifies a custom definition table, the operation flow passes to a first retrieve operation 810.

The first retrieve operation 810 extracts the row objects and identifiers needed to construct the requested custom definition table. As the row objects and identifiers are being extracted from the one or more non-standard definition tables 107, the first retrieve operation 810 links the type code entry and metadata description entry contained in each row object to the appropriate identifier. The type code entries, metadata description entries, corresponding identifiers, and in an embodiment, other metadata included within the retrieved row objects, are added to a data structure. The operation flow then passes to a provide operation 812. The provide operation 812 provides the data structure to the ObjectStore component 110 for use in constructing a custom definition table. The ObjectStore component 110 arranges the metadata and identifiers contained in the data structure into a custom definition table such that the type codes and metadata description entries are recognizable by the client application program 108. After the data structure is provided to the ObjectStore component 110, the operation flow concludes at the terminate operation 814.

If the query operation 808 determines that the request does not specify a custom definition table, but rather a standard definition table, the operation flow passes to a retrieve operation 809. The retrieve operation 809 retrieves the specified standard definition table 107 from the database 122. The operation flow then passes from the retrieve operation 809 to the provide operation 812. The provide operation 812 provides the standard definition table 107 to the ObjectStore component 110 such that the ObjectStore component 110 can manage retrieval, and in an embodiment, manipulation, of metadata contained within the standard definition table 107. After the standard definition table 107 is provided to the ObjectStore component 110, the operation flow concludes at the terminate operation 814.

It will be clear that the present invention is well adapted to attain the ends and advantages mentioned, as well as those inherent therein. While a presently preferred embodiment has been described for purposes of this disclosure, various changes and modifications may be made which are well within the scope of the present invention. For example, a request for a standard definition table made by a software module, e.g., 112, 114 and 116, may include a filter which defines certain row objects of the standard definition table that the software module, e.g., 112, 114 and 116, is requesting the ObjectStore component 110 to retrieve. If the filter is included in a request for a standard definition table that is not stored in either the session or instance cache, the ObjectStore component's 110 request to the server computer 120 includes the filter such that the query executed by the server computer 120 only retrieves row objects from the standard definition table that are included within the filter. If the filter is included within a request for a custom or standard definition table included within either the session or instance cache, the ObjectStore component applies the filter to the requested table such that row objects defined by the filter are the only row objects returned to the software module, e.g., 112, 114 and 116, or, alternatively, used by the ObjectStore component 110 to complete a specified GUI component. Furthermore, a metadata object is described herein as a standard definition table, a custom definition table and a row object of a standard or a non-standard definition table. In an alternative embodiment, a metadata object may be a column, or even a single entry, of a standard or non-standard definition table. Such metadata objects may be extracted using a filtering process like the process described above. Numerous other changes may be made which will readily suggest themselves to those skilled in the art and which are encompassed in the spirit of the invention disclosed and as defined in the appended claims.

What is claimed is:

1. A system for managing metadata for use by a client application program, the system comprising:
a presentation layer managing retrieval of a metadata object in response to a request for the metadata object from a software module of the client application program; and
a data layer storing the metadata object and accessible to the presentation layer such that the presentation layer may retrieve the metadata object from the data layer in response to the request from the software module.

2. A system as defined in claim 1, further comprising:
a middle-tier layer connected between the presentation layer and the data layer, retrieving the metadata object from the data layer and providing the metadata object to the presentation layer.

3. A system as defined in claim 2, wherein the presentation layer, the middle-tier layer and the data layer reside on one computing system.

4. A system as defined in claim 2, wherein the presentation layer resides on a first computing system and the middle-tier layer resides on a second computing system, wherein the presentation layer and the middle-tier layer communicate over a network connection.

5. A system as defined in claim 4, wherein the data layer resides on the second computing system.

6. A system as defined in claim 4, wherein the data layer resides on a third computing system, the middle-tier layer accessing the data layer over a communication link.

7. A system as defined in claim 2, wherein the presentation layer comprises:
an Object management component receiving the request from the software module, managing retrieval of the metadata object and providing the metadata object to the software module.

8. A system as defined in claim 7, wherein the Object management component directs the middle-tier layer to retrieve the metadata object in response to the received request from the software module.

9. A system as defined in claim 8, wherein the presentation layer comprises a cache memory storing the metadata object retrieved by the middle-tier layer.

10. A system as defined in claim 9, wherein the Object management component retrieves the metadata object from the cache memory in response to receiving a second request for the metadata object.

11. A system as defined in claim 7, wherein the data layer stores the metadata object as a standard definition table having one or more row objects, wherein each row object comprises a type code and a corresponding metadata description entry.

12. A system as defined in claim 7, wherein the Object management component constructs the metadata object using one or more row objects of one or more non-standard definition tables stored on the data layer responsive to the request by the software module.

13. A system as defined in claim 12, wherein the Object management component recognizes that the software module has requested retrieval of a custom metadata object based on a custom query being specified in the request, and in response, directs the middle-tier layer to execute the custom query to extract the one or more row objects from the one or more non-standard definition tables stored on the data layer.

14. A system as defined in claim 7, wherein the metadata object is a standard definition table having a plurality of row objects and a predetermined set of metadata fields, the Object management component retrieving the standard definition table and filtering the standard definition table by deleting one or more row objects from the standard definition table such that the standard definition table provided to the software module includes a specified set of row objects.

15. A system as defined in claim 7, wherein the Object management component populates a GUI component with metadata contained in the metadata object specified in the request by the software module.

16. A system as defined in claim 15, wherein the request by the software module comprises the GUI component.

17. A method for managing metadata for use by a client application, the method comprising:
receiving a request for a metadata object from a software module of the client application program;
retrieving the metadata object from a database in response to the request from the software module; and
providing the metadata object to the software module.

18. A method as defined in claim 17, wherein the retrieving act comprises:
communicating an identification of the metadata object to a server computer over a network connection, wherein the server computer accesses the database and extracts the metadata object.

19. A method as defined in claim 18, wherein the retrieving act further comprises:
receiving the metadata object from the server computer over the network connection.

20. A method as defined in claim 17, further comprising:
storing the metadata object retrieved from the database to a cache memory.

21. A method as defined in claim 20, wherein the retrieving act further comprises:
referencing the cache memory to determine whether the metadata object is stored therein; and
retrieving the metadata object from the cache memory if the metadata object is stored therein.

22. A method as defined in claim 17, wherein the metadata object is stored in the database as a standard definition table having row objects divided into one or more metadata fields, wherein the one or more metadata fields comprise a type code and a corresponding metadata description entry, the method comprising:
recognizing that the software module has requested retrieval of a standard metadata object based on detection of a definition table identifier being specified in the request.

23. A method as defined in claim 22, wherein the retrieving act comprises:
sending the definition table identifier to a server computer for accessing the standard definition table from the database; and
receiving the standard definition table from the server computer.

24. A method as defined in claim 23, further comprising:
filtering the standard definition table by deleting one or more row objects from the standard definition table such that the standard definition table provided to the software module includes a specified set of row objects.

25. A method as defined in claim 17, wherein the database stores non-standard definition tables having one or more metadata fields comprising a type code and a corresponding metadata description entry, the method further comprising:
recognizing that the software module has requested retrieval of a custom metadata object based on detection of a custom query identifier being specified in the request.

26. A method as defined in claim 25, further comprising:
constructing the custom metadata object using one or more row objects extracted from one or more non-standard definition tables, wherein the providing act comprises providing the custom metadata object to the software module requesting the custom metadata object.

27. A method as defined in claim 26, wherein the retrieving act further comprises:
communicating the custom query identifier to a server computer over a network connection, wherein the server computer extracts a custom query from the database based on the custom query identifier and executes the custom query to extract the one or more row objects from the one or more non-standard definition tables.

28. A method as defined in claim 27, wherein the retrieving act further comprises:
receiving the one or more row objects from the server computer over the network connection.

29. A method as defined in claim 17, further comprising:
populating a graphical user interface component with metadata contained in the retrieved metadata object, wherein the graphical user interface component is included within the request from the software module.

30. A method as defined in claim 29, wherein the providing act comprises:
providing the populated graphical user interface component to the software module.

31. A method for managing metadata for use by a client application program, the method comprising:
receiving a request for metadata over a communication link to an object management component managing retrieval of metadata for a plurality of software modules of the client application program;
executing a query for extracting metadata from a database;
receiving metadata specified in the request from the database; and
providing the received metadata to the object management component over the communication link.

32. A method as defined in claim 31, wherein the request specifies a custom query for extracting one or more metadata row objects from one or more definition tables stored in the database, the method further comprising:
retrieving the custom query from the database, wherein the executing act comprises executing the custom query to extract and receive the one or more metadata row objects from the one or more definition tables, wherein the one or more metadata row objects comprise a type code entry and a metadata description entry.

33. A method as defined in claim 32, wherein the providing act comprises:
associating the type code entries and metadata description entries of the one or more metadata row objects to identifiers recognizable by the object management component such that the type code entries and metadata description entries are manipulable by the object management component to construct a custom definition table formatted for recognition by the software modules of the client application program.

34. A method as defined in claim 31, wherein the request specifies a standard definition table stored in the database and having one or more row objects, the executing act comprising:
executing a standard query to extract and receive the standard definition table.

35. A method as defined in claim 34, wherein the request specifies a filter defining a certain set of row objects requested by the software module, the method further comprising:
discarding row objects of the standard definition table that are not included within the certain set of row objects.

36. A computer program storage medium readable by a computing system and encoding a computer program for managing metadata for use by a client application, the computer process comprising:
receiving a request for a metadata object from a software module of the client application program;
retrieving the metadata object from a database in response to the request from the software module; and
providing the metadata object to the software module.

37. A computer program storage medium as defined in claim 36, wherein the retrieving act comprises:
communicating an identification of the metadata object to a server computer over a network connection, wherein the server computer accesses the database and extracts the metadata object.

38. A computer program storage medium as defined in claim 37, wherein the retrieving act further comprises:
receiving the metadata object from the server computer over the network connection.

39. A computer program storage medium as defined in claim 36, the computer process further comprising:
storing the metadata object retrieved from the database to a cache memory.

40. A computer program storage medium as defined in claim 39, wherein the retrieving act further comprises:
referencing the cache memory to determine whether the metadata object is stored therein; and
retrieving the metadata object from the cache memory if the metadata object is stored therein.

41. A computer program storage medium as defined in claim 36, wherein the metadata object is stored in the database as a standard definition table having row objects divided into one or more metadata fields, wherein the one or more metadata fields comprise a type code and a corresponding metadata description entry, the method comprising:
recognizing that the software module has requested retrieval of a standard metadata object based on detection of a definition table identifier being specified in the request.

42. A computer program storage medium as defined in claim 41, wherein the retrieving act comprises:
sending the definition table identifier to a server computer for accessing the standard definition table from the database; and
receiving the standard definition table from the server computer.

43. A computer program storage medium as defined in claim 42, the computer process further comprising:
filtering the standard definition table by deleting one or more row objects from the standard definition table such that the standard definition table provided to the software module includes a specified set of row objects.

44. A computer program storage medium as defined in claim 36, wherein the database stores non-standard definition tables having one or more metadata fields comprising a type code and a corresponding metadata description entry, the method further comprising:
recognizing that the software module has requested retrieval of a custom metadata object based on detection of a custom query identifier being specified in the request.

45. A computer program storage medium as defined in claim 44, the computer process further comprising:
constructing the custom metadata object using one or more row objects extracted from one or more non-standard definition tables, wherein the providing act comprises providing the custom metadata object to the software module requesting the custom metadata object.

46. A computer program storage medium as defined in claim 45, wherein the retrieving act further comprises:
communicating the custom query identifier to a server computer over a network connection, wherein the server computer extracts a custom query from the database based on the custom query identifier and executes the custom query to extract the one or more row objects from the one or more non-standard definition tables.

47. A computer program storage medium as defined in claim 46, wherein the retrieving act further comprises:
receiving the one or more row objects from the server computer over the network connection.

48. A computer program storage medium as defined in claim 36, the computer process further comprising:
populating a graphical user interface component with metadata contained in the retrieved metadata object, wherein the graphical user interface component is included within the request from the software module.

49. A computer program storage medium as defined in claim 48, wherein the providing act comprises:
providing the populated graphical user interface component to the software module.
